(19) United States
(12) Patent Application Publication
(10) Pub. No.: US 2022/0067663 A1
(43) Pub. Date: Mar. 3, 2022

(54) SYSTEM AND METHOD FOR ESTIMATING WORKLOAD PER EMAIL

(71) Applicant: Capital One Services, LLC, McLean, VA (US)

(72) Inventors: Austin WALTERS, Savoy, IL (US); Anh TRUONG, Champaign, IL (US); Vincent PHAM, Champaign, IL (US); Jeremy GOODSITT, Champaign, IL (US); Mark WATSON, Sedona, AZ (US)

(21) Appl. No.: 17/003,274

(22) Filed: Aug. 26, 2020

(51) Int. Cl. G06Q 10/10; H04L 12/58; G06N 3/08

(52) U.S. Cl. CPC G06Q 10/107; H04L 51/04; G06N 3/08; H04L 51/26; H04L 51/22

(57) ABSTRACT

Embodiments of the present disclosure provide systems, methods, and devices for utilizing an artificial intelligence engine to determine a response time, urgency, or degree of importance associated with electronic communications. Example embodiments relate to a predictive model and development of a predictive model using an artificial intelligence system and/or machine learning techniques. Example embodiments of systems and methods may utilize AI based systems and models for facilitating communication and prioritizing electronic messages based on the priorities of the receiver or enterprise.

### FIELD OF THE INVENTION

This disclosure relates to artificial intelligence (AI)-based systems and methods for receiving a communication containing a set of variable values and determining a workload associated with the communication based on the variable values.

### BACKGROUND

Modern technology includes several forms of electronic communication including email, text messages, on-line messages, instant communication. Many individuals receive numerous electronic messages every day from a wide variety of sources. Some electronic messages require little to no response while other may require detailed and thoughtful responses. It can be difficult to determine how much effort will be required to respond to a particular electronic message without analyzing each message. An increasing proportion of electronic communication is unwanted “spam” messages that may be difficult to identify as such without opening and analyzing the message.

Time and resources spent analyzing electronic messages to determine if a response is necessary and how long a response will take could be used in other, more productive ways. Additionally, upon determining that a particular electronic message requires a detailed or time-intensive response, a user may close that message with the intention of responding at a later time. In this manner, important messages may be lost or forgotten about if the user does not remember to return to the message after determining the workload involved in responding.

These and other deficiencies exist. Therefore, a need exists for a system which estimates the response time required to respond to a particular electronic message and is able to provide a user with this information without the user analyzing the electronic message.

### SUMMARY

Aspects of the disclosed technology include artificial intelligence (AI) based systems and methods for developing predictive models which may be used to determine a response time associated with an electronic message and display that response time to a user without the user opening or studying the electronic message. By providing the user with an estimate of the amount of work required to respond, a user is able to prioritize emails that he is able to respond to at a given moment without spending time opening or studying emails he is unable to respond to at the time.

In some embodiments, AI systems may be used to analyze a wide variety of variables associated with a given electronic communication. Each of these variables may be analyzed using a predictive model or artificial intelligence engine to determine the amount of time a use will take to respond to the communication.

In some embodiments, the estimated response time may be a general average or may be the predicted response time for a particular individual or small group of individuals. In some embodiments, the estimated response time may be used as a proxy for the workload required to respond to a particular electronic message.

Embodiments of the present disclosure provide an artificial intelligence (AI) system comprising: a user interface displayed on a client device, the client device configured to receive an electronic message directed to a user; a message server hosting an application programming interface, wherein the message server is in data communication with the client device; and an AI engine, the AI engine in real-time communication with the application programming interface, wherein the AI engine is configured to: receive an electronic message from the message server; extract message information from the electronic message; apply a predictive model to the extracted message information to determine a response time associated with the electronic message, the response time indicating the predicted time required for the user to respond to the message; and display the response time associated with the electronic message on the user interface.

Embodiments of the present disclosure provide an artificial intelligence method comprising: receiving an electronic message from a message server; extracting message information from the electronic message using an artificial intelligence engine; applying a predictive model to the extracted message information using the artificial intelligence engine; determining, based on the predictive model, a response time associated with the electronic message; presenting the determined response time to a user via a user interface displayed on a client device before the user opens the electronic message; transmitting the extracted message information and determined response time to a database; monitoring the user response to the received electronic message in order to determine the accuracy of the determined response time associated with the electronic message; and adjusting the predictive model in response to the determined accuracy of the determined response time.

Embodiments of the present disclosure provide an artificial intelligence system comprising: a client device configured to display a user interface; a data storage containing one or more resolved electronic messages and one or more known response times associated with the one or more resolved electronic messages; and a server configured to transmit electronic messages to an AI engine, the AI engine in data communication with data storage and in data communication with the user interface via an application programming interface configured to transmit real time data, wherein the AI engine is configured to: receive an electronic message from the server; extract message information from the electronic message; apply a predictive model to the extracted message information to determine a response time associated with the received electronic message based on the extracted message information, wherein the predictive model is based on the one or more known response times associated with the one or more resolved electronic messages, and present the determined response time associated with the received electronic message to a user using the user interface before the user opens the received electronic message.

Further features of the disclosed design, and the advantages offered thereby, are explained in greater detail hereinafter with reference to specific example embodiments illustrated in the accompanying drawings.

### BRIEF DESCRIPTION OF THE DRAWINGS

FIG. 1 illustrates an artificial intelligence system according to one or more example embodiments.

FIG. 2 is a flow chart illustrating operation of an artificial intelligence system according to one or more example embodiments.

FIG. 3 illustrates a user interface according to one or more example embodiments.

FIG. 4 illustrates a user interface according to one or more example embodiments.

FIG. 5 is a flow chart illustrating operation of an artificial intelligence system according to one or more example embodiments.

FIG. 6 is a flow chart illustrating operation of an artificial intelligence system according to one or more example embodiments.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present disclosure provides systems, methods, and devices for developing and utilizing AI systems, an AI engine, machine learning techniques, and predictive modeling facilitating the determination of a time period required for responding to an electronic message. Embodiments described herein utilize AI based systems and models for facilitating communication and prioritizing responses to electronic messages.

Many electronic messaging programs allow a user to view a list of received messages prior to selecting or open a particular message. Some programs provide the user with a limited amount of information such as, for example, the name or address of the sender of the electronic message, a subject line, an initial portion of the message, or the time the message was sent. This information may provide the user, or the recipient of an electronic message, with an indication of what the message is about but is typically insufficient for the user to determine how much work is required to properly respond to the message. This can lead to a user wasting a significant amount of time opening and analyzing emails which are unwanted or which do not require a response. It can also lead to a user opening a message and, upon analyzing the message, determining that a proper response requires more time than the user can dedicate to that task at the moment. In this case, the user may move on to other emails in order to clear out an inbox and may forget to return to the potentially important email that required a detailed response. The overall result is wasted time and missed or delayed communication between parties.

It is understood that the exemplary embodiments presented herein are for illustrations sake. While embodiments are often described in the context of an email communication, an ordinary artisan will understand that the disclosed AI system may be applied to any other form of electronic communication.

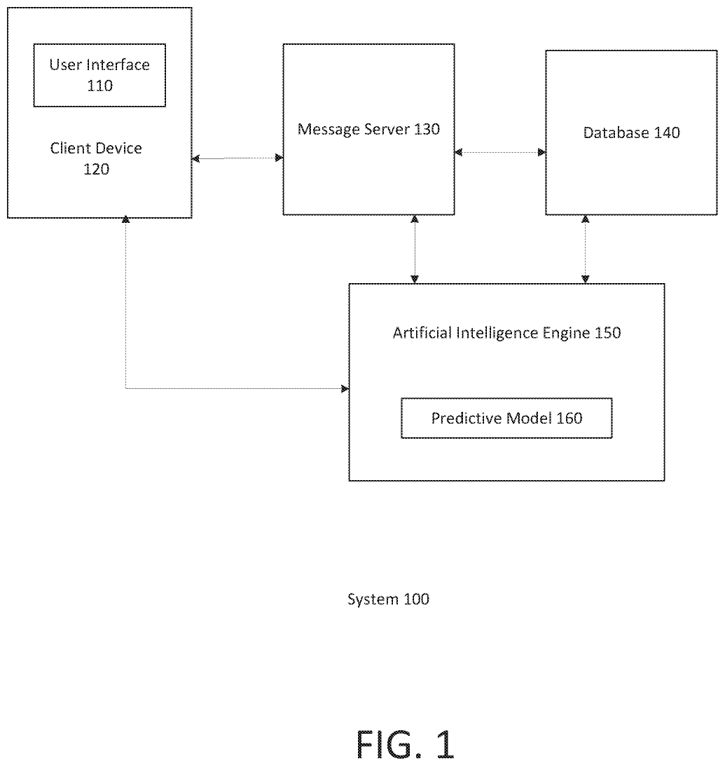

FIG. 1 illustrates an artificial intelligence system according to one or more example embodiments. The system may include a user interface 110 which is displayed on a client device 120, a message server 130 that hosts an application programming interface, at least one database 140, and an artificial intelligence engine 150 which may apply a predictive model 160.

The user interface 110 may be, but is not limited to being an email client, email reader, mail user agent, instant messaging program, intra-office communication program, web application, or any suitable program for displaying an electronic message to a user.

The client device 120 may be, but is not limited to being a smartphone, laptop, desktop computer, tablet computer, personal digital assistant, thin client, fat client, Internet browser, customized software application or kiosk. It is further understood that the client device 120 may be of any type of device that supports the communication and display of electronic communication data and user input. The present disclosure is not limited to a specific number of client devices, and it is understood that the system 100 may include a single client device or multiple client devices.

Client device 120 may include one or more processors, memory, and application software configured for execution on the client device to carry out some or all of the features described herein, such as, for example, providing or controlling user interface 110.

Client device 120 may further include a communications interface providing wired and/or wireless data communication capability. These capabilities may support data communication with a wired or wireless communication network, including the Internet, a cellular network, a wide area network, a local area network, a wireless personal area network, a wide body area network, any other wired or wireless network for transmitting and receiving a data signal, or any combination thereof. This network may include, without limitation, telephone lines, fiber optics, IEEE Ethernet 902.3, a wide area network, a local area network, a wireless personal area network, a wide body area network or a global network such as the Internet. Client device 120 may also, but need not, support a short-range wireless communication interface, such as near field communication, radio-frequency identification, and/or Bluetooth.

Client device 120 further includes at least one display and input device. The display may be any type of device for presenting visual information such as a computer monitor, a flat panel display, and/or a mobile device screen, including liquid crystal displays, light-emitting diode displays, plasma panels, or cathode ray tube displays. The input devices may include any device for entering information into the client devices that is available and supported by the client device 120, such as a touch-screen, keyboard, mouse, cursor-control device, touch-screen, microphone, digital camera, video recorder or camcorder. These devices may be used to enter information and interact with the system 100 as described herein.

The message server 130, database 140, and AI engine 150 may be, or may be run on, dedicated server computers, such as bladed servers, or may be personal computers, laptop computers, notebook computers, palm top computers, network computers, mobile devices, or any processor-controlled device capable of supporting the system 100. One or more of message server 130, database 140, and AI engine 150 may each include memory, application software and a processor configured to carry out some or all of the features described herein.

While FIG. 1 illustrates a message server 130, a database 140, and an AI engine 150, it is understood that other embodiments may use multiple computer systems or multiple servers as necessary or desired to support the user and may also use back-up or redundant servers to prevent network downtime in the event of a failure of a particular server. It is further understood that in some embodiments, a plurality of additional databases or data servers may store information and/or data utilized by the AI engine.

In some embodiments, message server 130 may transmit an electronic message, such as, for example, an email message, directly or indirectly to the client device 120. In such embodiments, the message server 130 may also transmit electronic messages to the AI engine 150. In some embodiments, the message server 130 hosts an application programming interface (API) which enables real time communication between the message server and other components of system 100.

In some embodiments, the AI engine 150 may be in data communication with the user interface 110, client device 120, message server 130, and/or database 140, and may be configured to receive an electronic message from the message server 130 and extract message information from the electronic message. In some embodiments, the AI engine 150 may be in real-time communication with an API hosted by the message server. In some embodiments, after receiving an electronic message from the message server 130, the AI engine may transmit the message to client device 120. In some embodiments, the message server 130 may not be in direct communication with the user interface 110 or client device 120.

Message information may include, but is not limited to, the text of a message, total word count, noun count, verb count, key words, key word count, subject line text, sender information, sender name, sender IP address, number of recipients, recipient information for one or more recipients, recipient IP address, time of transmission, time of receipt, day of transmission, or day of receipt. In some embodiments, the extracted message information may include the structure complexity of a message or document, the time elapsed since a previous draft of a document was sent, the response time associated with a previous draft document, and/or the average response time between a particular sender and receiver.

In some embodiments, the AI engine 150 may extract attachment information from any attachments associated with an electronic communication. Attachment information may include, but is not limited to, number of attachments, file type of each attachment, attachment text, attachment word count, attachment noun count, attachment verb count, attachment key words, attachment key word count, attachment images, or attachment image content.

In some embodiments, the AI engine ignores stop words when extracting message information or attachment information from a received electronic message and/or attachment. This may help decrease the computational burden on the AI engine and lead to fast and/or more accurate determinations of response time. In some embodiments, the AI engine extracts message and/or attachment information from a received message or attachment using only nouns and/or verbs. This approach may also serve to limit the total computational load on the AI engine resulting in greater speed and accuracy of the determined response time. In some embodiments, the extracting message information and/or attachment information comprises one-hot encoding and/or learned embedding of the message and/or attachment texts.

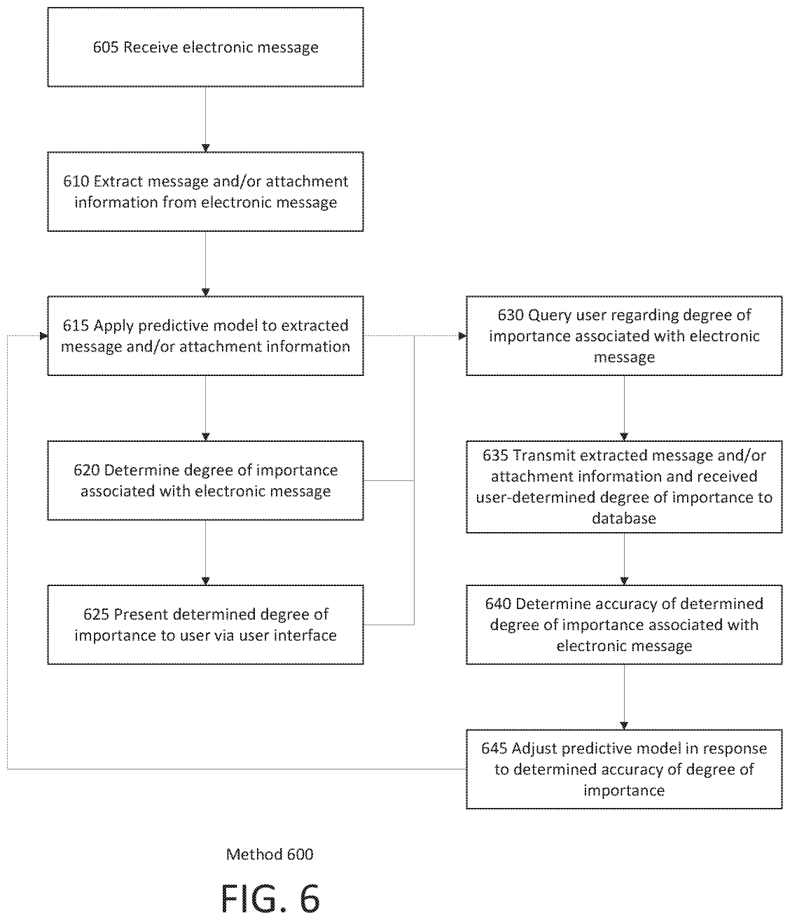

In some embodiments, the AI engine ignores sender information when extracting message information from the received electronic message. This approach may be used to avoid biasing messages received from certain senders. In some enterprises, a single individual may send a large number of communications which do not require a response or do not require a quick response. In such a scenario, the response times calculated for that sender may be skewed and lead to an inaccurate response time for messages that do require a timely response. As described in more detail below with respect to FIG. 6, information such as sender, etc. may be used to determine degree of perceived importance for one or more electronic messages, which may in turn be used in determining whether and how to display electronic messages—such as, for example, the order of listing of messages or another indication of importance.

The AI engine 150 may apply a predictive model 160 to the extracted message information and/or attachment information to determine a response time associated with the electronic message. The response time indicates the predicted time required for the user to respond to the message. In some embodiments, the response time may indicate how long after initially opening the electronic message a user will respond. In some embodiments, the predictive model 160 may include continuous learning capabilities that allow the model to adjust itself or its determinations as more information becomes available. In some embodiments, the AI engine 150 may transmit the extracted message information, attachment information and/or determined response time to the database 140.

It will be appreciated that key words may be any word or phrase that is more strongly linked to a response time than other words. In one non-limiting example, a user may receive an email that contains the name of a particular client that has specialized demands. In this example, the name of the client may be a key word which is strongly associated with a longer response time. In another non-limiting example, the name of a supervisor or client contact may be a key word. In this example, the name of a supervisor may indicate that the response must be well crafted and/or thoroughly reviewed, thereby leading to a longer response time.

In an example embodiment, AI engine 150 may be in data communication with database 140. The AI engine 150 may utilize information contained on database 140 in order to determine a response time associated with an electronic message. In some embodiments, database 140 may contain information associated with resolved electronic messages that have already received a response. Resolved electronic messages have a known response time associated with the message. In some embodiments, the AI engine may extract message and/or attachment information from resolved electronic messages in order to develop a predictive model based on the message and/or attachment information and the known response times associated with the resolved electronic messages. In some embodiments, the predictive model may be trained using message information extracted from the resolved electronic messages and the known response times associated with the resolved electronic messages. In some embodiments, the one or more users who have previously responded to resolved electronic messages may have the same the same or similar job title, job function, company experience, supervisor(s) and/or direct reports. By selecting a subset of resolved electronic messages that have a similar sender or recipient, a predictive model may be more closely tailored to a specific category or sub-set of users.

In an example embodiment, the predictive model may be a supervised learning model. The predictive model may rely on message information, attachment information, and known response times to resolved electronic messages. In some embodiments, the AI engine may monitor a user's response to a received electronic message in order to determine the accuracy of the determined response time. In some embodiments, the AI engine may adjust the predictive model in response to the determined accuracy of the determined response time to increase the accuracy or utility of the model. In some embodiments, the AI engine 150 may transmit the extracted message and/or attachment information and determined response time to a database.

In some embodiments, the subset of information used by the AI engine and/or predictive model may increase, may decrease, or may otherwise be modified over time as the development of the predictive model continues.

The predictive model may be developed by machine learning algorithms. In some embodiments, the machine learning algorithms employed may include gradient boosting machine, logistic regression, convolutional neural networks (CNNs), recurrent neural networks (RNNs), long short-term memory networks (LSTMs), other neural networks, one-hot encoding, learned embedding, or a combination thereof; however, it is understood that other machine learning algorithms may be utilized.

As discussed herein, the example embodiments of the AI engine and predictive model can utilize machine learning to determine response times associated with electronic messages. The exemplary machine learning can utilize message information, attachment information, resolved electronic messages, to make the determination, and various predictive models can be generated and trained using this data. The exemplary systems and methods can then apply the generated models to determine response times and perform other functions as described herein.

The exemplary systems and methods can utilize various neural networks, such as CNNs RNNs, to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of LSTMs and gated recurrent units

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

In some embodiments, methods and procedures in accordance with the present disclosure can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the client device 120, message server 130, database 140, and/or AI engine 150, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

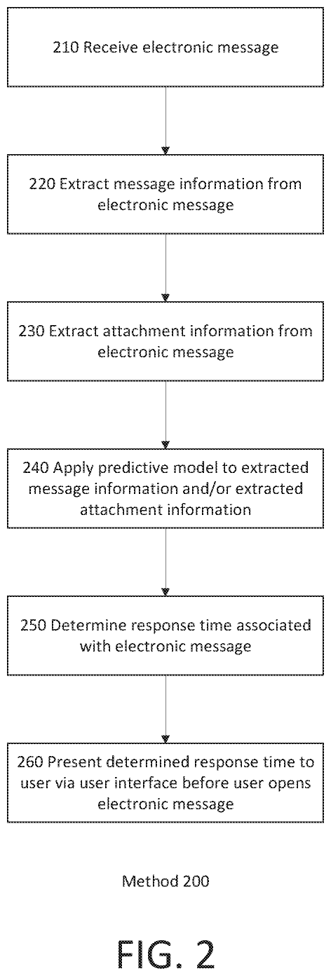

FIG. 2 is a flow chart illustrating operation of the disclosed artificial intelligence system according to one or more example embodiments. The method 200 of FIG. 2 may reference the same or similar components as illustrated in FIG. 1.

At block 210, the AI engine may receive an electronic message from a message server. The AI engine and message server may be connected via an API. In some embodiments, the message server may transmit the electronic message to the AI engine in real- or near real-time.

At block 220, the AI engine may extract message information from the received electronic message. Message information may be extracted from an electronic message using a variety of techniques. In some embodiments, every word in the message may be analyzed. In some embodiments, some words will be ignored when extracting message information. In some embodiments, only nouns and/or verbs may be utilized when extracting message information. In some embodiments, message information such as, e.g., sender, recipient, date/time, etc. may be extracted from metadata accompanying the received electronic message.

At block 230, the AI engine extracts attachment information from the received electronic message. It will be appreciated that files containing more than text may be attached to an electronic message. In some embodiments, extracting attachment information may depend on the file type of the attachment and/or the non-text contents of an attachment. In some embodiments, an attachment may contain only text, or text and other identifiable objects. In such embodiments, extracting attachment information may utilize the same or similar techniques as extracting message information from an electronic message.

At block 240, the AI engine may apply a predictive model to the extracted message and/or attachment information. The predictive model may be developed using message and/or attachment data extracted from these resolved electronic messages that have previously received a response, thereby creating a set of electronic messages with a known response time.

At block 250, the AI engine may determine, based on the predictive model, a response time associated with an electronic message. Once a response time associated with an electronic message has been determined, the AI engine may transmit the determined response time to a client device for display via a user interface.

At block 260, the determined response time may be presented to a user via the user interface. In some embodiments, the user may see the determined response time prior to opening an electronic message. This allows the user to determine if he should open the electronic message immediately, or at a later time—such as, e.g., when the user may have more time to develop an appropriate response to the electronic message.

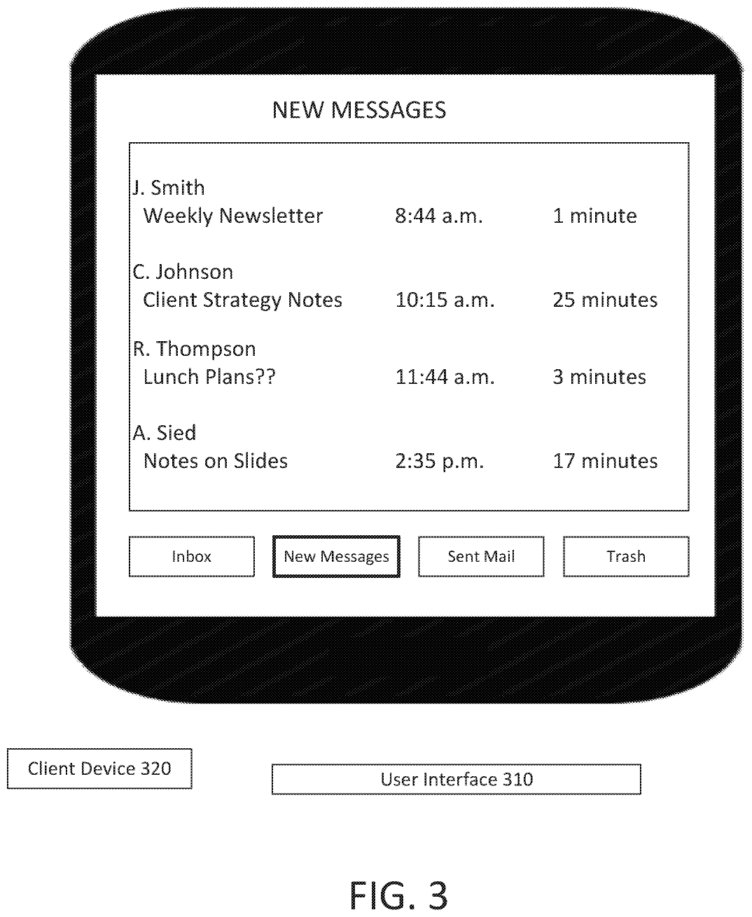

FIG. 3 illustrates an example user interface according to one or more example embodiments. In FIG. 3, user interface 310 is displayed on client device 320. The example user interface in FIG. 3 shows a list of new messages received by a user including the name of the sender, the subject line, the time the message was received, and the estimated response time. In some embodiments, a portion of the message text may also be displayed in this screen. As shown at the bottom of the screen, there are four selectable menu functions, including Inbox (which may, when selected, display a list of messages previously received or reviewed by the user), New Messages (example display shown in the screen in FIG. 3), Sent Mail (which may, when selected, display a list of messages previously sent by the user), and Trash (which may, when selected, display a list of messages previously deleted by the user). Other selectable menu functions may also be presented to the user.

In some embodiments, messages may be displayed in ranked order based, for example, on the determined response time.

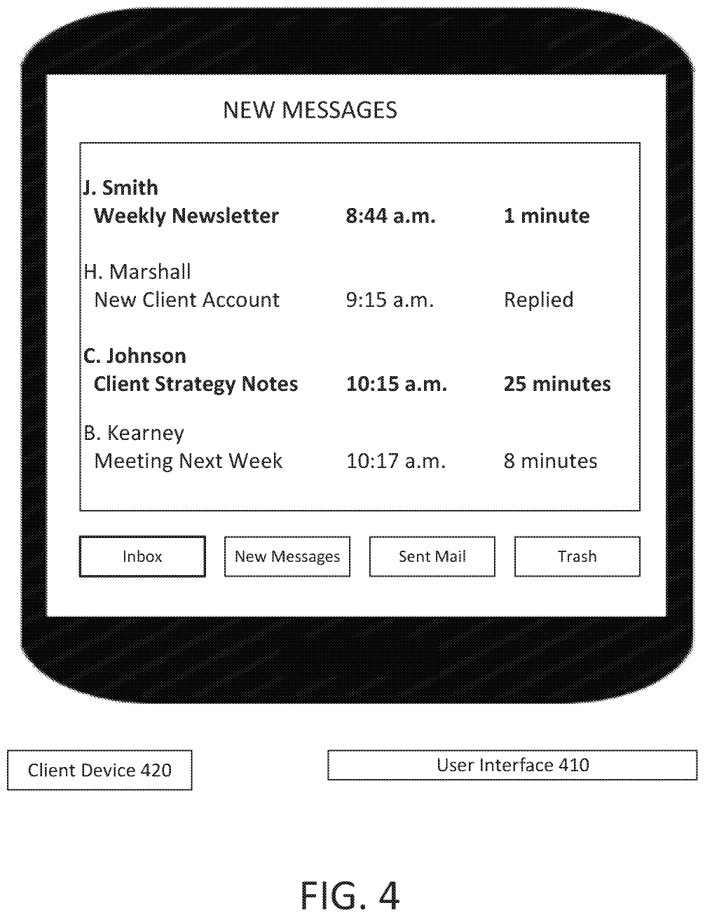

FIG. 4 illustrates another example user interface according to one or more example embodiments. In FIG. 4, user interface 410 is displayed on client device 420. Similar to FIG. 3, at the bottom of the screen there are four selectable menu functions, including Inbox, New Messages, Sent Mail, and Trash. The example user interface in FIG. 4 shows the display of the inbox for a user including a list of messages in the inbox. In some embodiments, new or unread messages may be presented in bold font to indicate that the user has not opened these messages. Messages that the user has opened and/or read may be presented in standard font. In some embodiments, the estimated response time may be presented for both opened and unopened messages. In some embodiments, the estimated response time may be replaced with an indicator that the user has already replied to an electronic message. In some embodiments, rather than presenting a specific response time, a message may be marked with a response time indicator such as, for example, “less than 3 minutes” or “greater than 10 minutes.” In some embodiments, messages may be color coded according to the determined response time. For example, a message associated with a response time of less than three minutes may be shaded in green, a message associated with a response time of between 3 and 10 minutes may be shaded in yellow, and a message associated with a response time of greater than 10 minutes may be shaded in orange. It will be appreciated that many other methods of marking an electronic message may be used to indicate the determined response time.

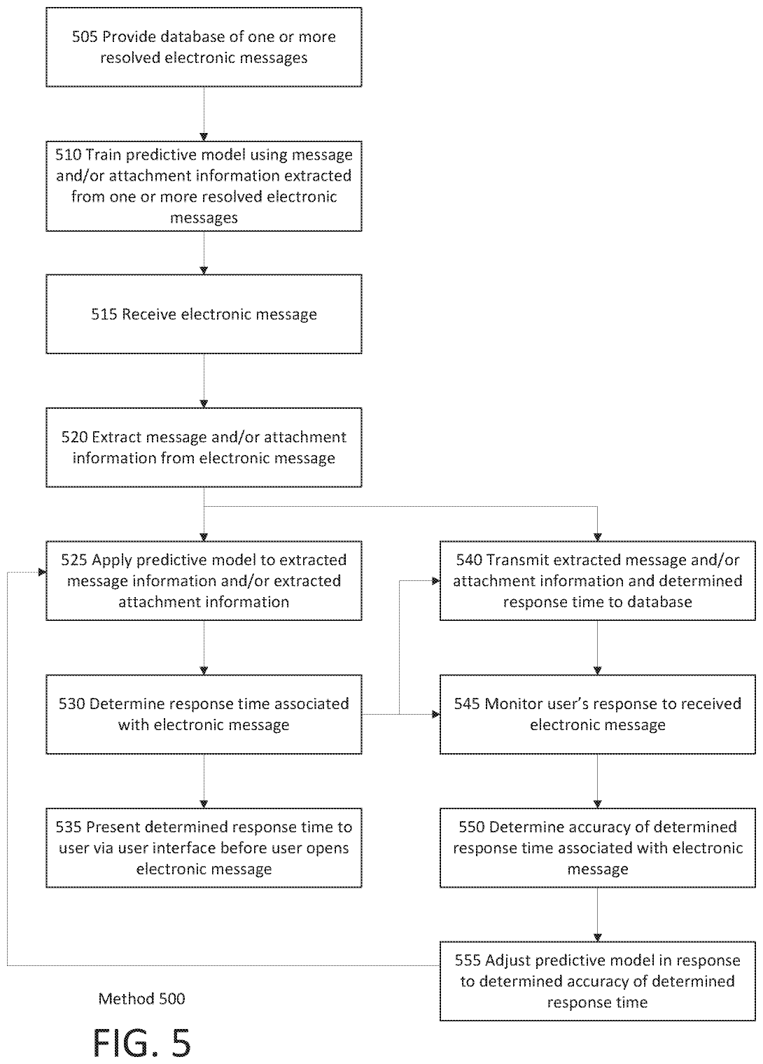

FIG. 5 shows a flow chart illustrating operation of the disclosed artificial intelligence system according to one or more example embodiments. Method 500 of FIG. 5 may include capturing additional information to provide feedback to a predictive model. Method 500 may reference the same or similar components as illustrated in FIGS. 1-4.

At block 505, a database containing one or more resolved electronic messages is provided. Resolved electronic messages are electronic messages which have previously received a response and therefore are associated with a known response time. By extracting message and/or attachment information from the resolved electronic messages, connections may be drawn between the extracted message information and the known response times.

At block 510, the predictive model may be trained using message and/or attachment information extracted from the one or more resolved electronic messages and the known response times associated with the one or more resolved electronic messages. Once the predictive model has been trained using the extracted training data, the predictive model may be applied to un-resolved emails and used to determine response times for incoming emails in real time or near real time.

At block 515, the AI engine may receive an electronic message. In some embodiments, the AI engine may receive an electronic message from a message server. The AI engine may be in data communication with the message server through an API which enables real time data communication.

At block 520, the AI engine may extract message information and/or attachment information from the received electronic message. Extracting message information and/or attachment information from the received electronic message may occur in the same or similar manner as described above with reference to FIG. 2 (including blocks 220 and 230).

At block 525, the AI engine may apply a predictive model to the extracted message information and/or extracted attachment information. In some embodiments, the trained predictive model may be applied to electronic messages received in real time. The predictive model may initially be very accurate or may require additional training as the system is deployed over time.

At block 530, the AI engine may determine, based on the predictive model, a response time associated with the received electronic message.

At block 535, the determined response time for the received electronic message may be presented to a user via a user interface before the user opens the received electronic message.

At block 540, the AI engine may transmit extracted information and determined response time to a database. The transmitting may occur upon performance of block 520, when the AI engine extracts message and/or attachment information from the electronic message, and/or upon performance of block 530, when the AI engine determines a response time. This database may be the same database containing one or more resolved electronic messages provided at block 505 or may be a separate database.

At block 545, the user's response to the received electronic message is monitored. By monitoring the user's response, a known response time may be established for the received electronic message.

At block 550, the AI engine may determine the accuracy of the response time determined based on the predictive model by comparing the determined response time associated with the electronic message to the actual time it took the user to respond to the electronic message. This comparison may be applied to numerous electronic messages and the associated responses from a single user or to the messages and responses associated with a category or sub-category of users. In one non-limiting example, all of the employees who work for a particular department or are at a particular level may be considered a category of employee. In another non-limiting example, all of the employees who report to a single manager or a group of managers may be considered a sub-category. By comparing the actual response times associated with multiple electronic messages to the determined response times associated with those messages, a more accurate determination of the accuracy of the predictive model may be determined.

At block 555, the AI engine may adjust the predictive model in response to the determined accuracy. By adjusting the predictive model as new or additional training data becomes available, some embodiments of the system may be continuously improved. In some embodiments, when the predictive model has been adjusted, as in block 555, the revised predictive model may be applied to the extracted information in block 525. At that point a new determined response time may be determined and compared with the actual response time. This feedback loop may be used to develop a highly accurate predictive model over time.

In some embodiments, the determined response time may not be displayed to the user until the accuracy of the predictive model exceeds a pre-determined threshold. This allows a company or enterprise to deploy the disclosed AI system and refine the system using real data without the potential confusion caused by inaccurate or not-sufficiently-accurate determined response times.

In some embodiments, the determined response time may be used to determine the workload associated with an electronic communication. In such embodiments, the determined response time may indicate the amount of time it will take to respond to an electronic communication after a user opens the message.

In some embodiments, the determined response time may be used to determine the urgency associated with an electronic communication. In such embodiments, the determined response time may indicate how urgent the receiver of the electronic communication, rather than the sender, considers the communication. In some embodiments, the determined response time may be based on the time at which the user is first shown by the user interface that they have received an electronic communication, rather than when the user opens the electronic communication.

FIG. 6 shows a flow chart illustrating operation of the disclosed artificial intelligence system according to one or more example embodiments. Method 600 of FIG. 6 may include determining a degree of importance. The method 600 of FIG. 6 may reference the same or similar components as illustrated in FIGS. 1-5.

In some embodiments, the AI system may determine a degree of perceived importance rather than, or in addition to, a response time. In such embodiments, an AI engine receives an electronic message from a message server and extracts message and/or attachment information. The AI engine may apply a predictive model to the extracted message and/or attachment information to determine the degree of importance associated with the electronic message. In some embodiments, the predictive model may be trained using training data which has been manually marked with an assigned degree of importance.

At block 605, the AI engine may receive an electronic message. In some embodiments, the AI engine may receive an electronic message from a message server. The AI engine may be in data communication with the message server through an API which enables real time data communication.

At block 610, the AI engine may extract message and/or attachment information from the received electronic message. Extracting message information and/or attachment information from the received electronic message may occur in the same or similar manner as described above with reference to FIG. 2 (including blocks 220 and 230).

At block 615, the AI engine may apply a predictive model to the extracted message and/or attachment information. As the determination of a degree of importance may be subjective, the predictive model may be trained using a dataset in which electronic messages have been assigned a degree of importance by a supervisor or other arbiter of importance regarding electronic messages. In some embodiments, the predictive model may be trained in an ongoing manner based on user input regarding the degree of importance associated with an electronic message.

At block 620, the predictive model may determine a degree of importance associated with an electronic message based on the extracted message information and/or attachment information. In some embodiments, the determined degree of importance may correspond to the goals of a user or enterprise, such as, for example, providing a particular set of clients with enhanced services or complying with directions from a supervisor. In some embodiments, the determine degree of importance may relate to a topic or subject matter the user or enterprise values or prioritizes. It will be appreciated that the degree of importance may be unrelated to a determined response time or even a need to respond. In a non-limiting example, an electronic communication containing a news article related to a client, potential client, developing technology, or other topic the user or enterprise has determined to be highly important may be marked with a high degree of importance but require no response at all. In this example, the electronic communication may be determined to be very important because the user may be interested in understanding the information contained within the electronic communication but the user may not ever need to respond to the electronic communication.

At block 625, the determined degree of importance may be presented to a user via a user interface. In some embodiments, the determined degree of importance may not be shown to the user until the predictive model has demonstrated a predetermined degree of accuracy, has received a predetermined amount of training, and/or has received a predetermined amount of user input regarding the determined degree of importance.

At block 630, the AI engine may query a user regarding the degree of importance the user assigns to an electronic message. This may, in some embodiments, be performed during a training period. In some embodiments, the user response to such a query may be used to train the predictive model or may be used to determine the accuracy of the predictive model. In some embodiments, the user interface may be configured to receive a response to the query via a client device.

At block 635, the extracted message and/or attachment information may be transmitted to a database along with the user determined degree of importance. In some embodiments, the database may be used to train the predictive model or to train future deployments of a predictive model.

At block 640, the AI engine may determine the accuracy of the predictive model determined degree of importance associated with an electronic message. The accuracy of the predictive model may be determined by comparing the predictive model determined degree of importance associated with the electronic message to the user determined degree of importance. This comparison may be applied to numerous electronic messages and the associated determinations or importance received from a single user or to the messages and determinations of importance received from a category or sub-category of users. In some embodiments, a third party, such as a supervisor or manager, may be queried regarding the degree of importance associated with an electronic communication that is sent to a user.

At block 645, the AI engine may adjust the predictive model in response to the determined degree of accuracy. In some embodiments, the predictive model may be adjusted in an ongoing manner. By adjusting the predictive model as new or additional training data becomes available, some embodiments of the system may be continuously improved or be adjusted to adapt with the changing goals or priorities of a user or organization. In some embodiments, when the predictive model is adjusted, the revised predictive model may be applied to the extracted message information as in block 615. At that point a new degree of importance may be determined and compared with the received user determinations of importance. This feedback loop may be used initially, periodically, or continuously to develop a more accurate predictive model over time.

In some embodiments, an indicator of the determined degree of importance may be presented to a user via a user interface. In some embodiments, the indicator of importance may be presented as one of “low”, “medium”, or “high”. In some embodiments, the indicator of importance may be presented on a numeric scale such as, for example, from one to ten. In some embodiments, the electronic message may be color coded to indicate the determined degree of importance associated with the electronic message.

It will be appreciated that in some embodiments, the determined degree of importance may not rely on input from the sender of the electronic message. This reduces or avoids a sender marking their own messages as high priority or urgent if the predictive model does not determine the messages are genuinely important. By utilizing a predictive model, a more objective determination of importance may be determined. In some embodiments, the predictive model may be tailored to the specific preferences of an individual user.

Multiple embodiments of the disclosed systems with various features are disclosed herein. It will be appreciated that the features and elements of the various disclosed embodiments may be utilized with other disclosed embodiments.

In some embodiments, every electronic communication that is sent by or received by a member of an organization may be analyzed by the disclosed AI engine. By determining a response time or degree of importance associated with every communication, a coherent, enterprise-wide system may be developed or deployed.

In some embodiments, the AI system may be implemented as a browser extension, plug-in, or additional feature to an established electronic messaging program.

In some embodiments, the AI engine may monitor a user's activity while a particular electronic message is open. In such embodiments, if the user begins to work on a separate project while the electronic message is open, the AI engine may adjust a determination of response time in order to avoid producing skewed results caused by a user leaving a message open while working on other projects.

The description of embodiments in this disclosure provides non-limiting representative examples referencing figures and numerals to particularly describe features and teachings of different aspects of the disclosure. The embodiments described should be recognized as capable of implementation separately, or in combination, with other embodiments from the description of the embodiments. A person of ordinary skill in the art reviewing the description of embodiments should be able to learn and understand the different described aspects of the disclosure. The description of embodiments should facilitate understanding of the disclosure to such an extent that other implementations, not specifically covered but within the knowledge of a person of skill in the art having read the description of embodiments, would be understood to be consistent with an application of the disclosure.

Throughout the specification, reference is made to an AI engine applying a predictive model. It will be understood that the AI engine may be any software, program, or application and that the predictive model may be any tool, database, dataset, software, program, or application which allows the AI engine to determine the likelihood or probability of a set of information or variables leading to a particular condition.

Throughout the specification, reference is made to an AI engine receiving information from a variety of sources. It will be understood that the AI engine may receive information directly or indirectly from a database, server, memory and/or computer. The components from which the AI engine receives information or data may be located remotely, locally, or, in some cases, be integral to the AI engine.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An artificial intelligence (AI) system comprising:
a user interface displayed on a client device, the client device configured to receive an electronic message directed to a user;
a message server hosting an application programming interface, wherein the message server is in data communication with the client device; and
an AI engine, the AI engine in real-time communication with the application programming interface, wherein the AI engine is configured to:
receive an electronic message from the message server;
extract message information from the electronic message;
apply a predictive model to the extracted message information to determine a response time associated with the electronic message, the response time indicating the predicted time required for the user to respond to the message; and
display the response time associated with the electronic message on the user interface.

2. The system of claim 1, wherein the AI engine is further configured to monitor the user response to the received electronic message in order to determine the accuracy of the determined response time.

3. The system of claim 2, wherein the AI engine is further configured to adjust the predictive model in response to the determined accuracy of the determined response time.

4. The system of claim 1, wherein the AI engine is further configured to transmit the extracted message information and determined response time to a database.

5. The system of claim 1, further comprising a database containing resolved electronic messages one or more users have previously responded to and a calculated known response time associated with each resolved electronic message.

6. The system of claim 5, wherein the predictive model is configured to be trained using message information extracted from the resolved electronic messages and the known response times associated with the resolved electronic messages.

7. The system of claim 6, wherein the predictive model is further configured to be trained using a convolutional neural network.

8. The system of claim 5, wherein the one or more users who have previously responded to resolved electronic messages have the same the same job title.

9. The system of claim 1, wherein the message information comprises one or more of message text, word count, noun count, verb count, subject line text, sender information, number of recipients, recipient information, time of transmission, time of receipt, day of transmission, or day of receipt.

10. The system of claim 1, wherein the AI engine is further configured to extract attachment information from the electronic message and to apply a predictive model to the extracted attachment information to determine a response time associated with the electronic message, wherein the attachment information comprises one or more of number of attachments, attachment content, or attachment text.

11. The system of claim 1, wherein extracting message information comprises one-hot encoding or learned embedding of the message text.

12. The system of claim 1, wherein the response time associated with the electronic message indicates how long after initially opening the electronic message the user will respond.

13. The system of claim 1, wherein the AI engine is further configured to ignore stop words when extracting message information from a received electronic message.

14. The system of claim 1, wherein the received electronic message comprises text and wherein AI engine is further configured to extract message information from the text of the received message using only nouns and verbs.

15. The system of claim 1, wherein the AI engine is further configured to ignore sender information when extracting message information from the received electronic message.

16. An artificial intelligence method comprising:
receiving an electronic message from a message server;
extracting message information from the electronic message using an artificial intelligence engine;
applying a predictive model to the extracted message information using the artificial intelligence engine;
determining, based on the predictive model, a response time associated with the electronic message;
presenting the determined response time to a user via a user interface displayed on a client device before the user opens the electronic message;
transmitting the extracted message information and determined response time to a database;
monitoring the user response to the received electronic message in order to determine the accuracy of the determined response time associated with the electronic message; and
adjusting the predictive model in response to the determined accuracy of the determined response time.

17. The method of claim 16, wherein the predictive model is built by machine learning using at least one of the following: gradient boosting machine, logistic regression, recurrent neural networks, convolutional neural networks, one-hot encoding, or learned embedding.

18. The method of claim 16, further comprising providing a database of one or more resolved electronic messages a user has previously responded to, the database containing known response times associated with the one or more resolved electronic messages, the database in data communication with the artificial intelligence engine.

19. The method of claim 18, further comprising training the predictive model using message information extracted from the one or more resolved electronic messages and the known response times associated with the one or more resolved electronic messages.

20. An artificial intelligence system comprising:
a client device configured to display a user interface;
a data storage containing one or more resolved electronic messages and one or more known response times associated with the one or more resolved electronic messages; and
a server configured to transmit electronic messages to an AI engine, the AI engine in data communication with data storage and in data communication with the user interface via an application programming interface configured to transmit real time data, wherein the AI engine is configured to:
receive an electronic message from the server;
extract message information from the electronic message;
apply a predictive model to the extracted message information to determine a response time associated with the received electronic message based on the extracted message information, wherein the predictive model is based on the one or more known response times associated with the one or more resolved electronic messages, and
present the determined response time associated with the received electronic message to a user using the user interface before the user opens the received electronic message.
